(19) United States
(12) Patent Application Publication
(10) Pub. No.: US 2012/0317425 A1
(43) Pub. Date: Dec. 13, 2012

(54) POWER SUPPLY CONTROL SYSTEM AND METHOD

(75) Inventor: WEI SHAO, Shenzhen City (CN)

(73) Assignees: HON HAI PRECISION INDUSTRY CO., LTD., Tu-Cheng (TW); HONG FU JIN PRECISION INDUSTRY (ShenZhen) Co., LTD., Shenzhen City (CN)

(21) Appl. No.: 13/459,124

(22) Filed: Apr. 28, 2012

(30) Foreign Application Priority Data
Jun. 13, 2011 (CN) 201110157291.1

(51) Int. Cl. G06F 1/26

(52) U.S. Cl. 713/300

(57) ABSTRACT

A remote computer can be used to control power supply devices corresponding to baseboard management controllers (BMCs) of cloud servers of a data center. The remote computer writes parameters into the BMC of the remote computer. The remote computer obtains information from each of the BMCs of the cloud servers. The remote computer sends a command every time interval to each of the BMCs of the cloud servers in a sequence to start the power supply devices corresponding to each of the BMCs of the cloud servers according to the obtained information.

### BACKGROUND

1. Technical Field

The embodiments of the present disclosure relate to cloud computing technology, and particularly to a power supply control system and method via cloud computing.

2. Description of Related Art

A data center is a facility which houses a large number of computers and stores huge amounts of data. If the large number of the computers starts at the same time (e.g., 6:00 AM), a power supply of the data center may be overloaded. At present, a user may manually set a random time in a baseboard management controller (BMC) to start some computers at different times from other computers. However, it is not convenient to manually set the random time in each of the large number of the computers. This is tedious and time consuming and thus, there is room for improvement in the art.

### BRIEF DESCRIPTION OF THE DRAWINGS

FIG. 1 is a system view of one embodiment of a power supply control system.

FIG. 2 is a block diagram of one embodiment of a cloud server included in FIG. 1.

FIG. 3 is a flowchart of one embodiment of a power supply control method.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

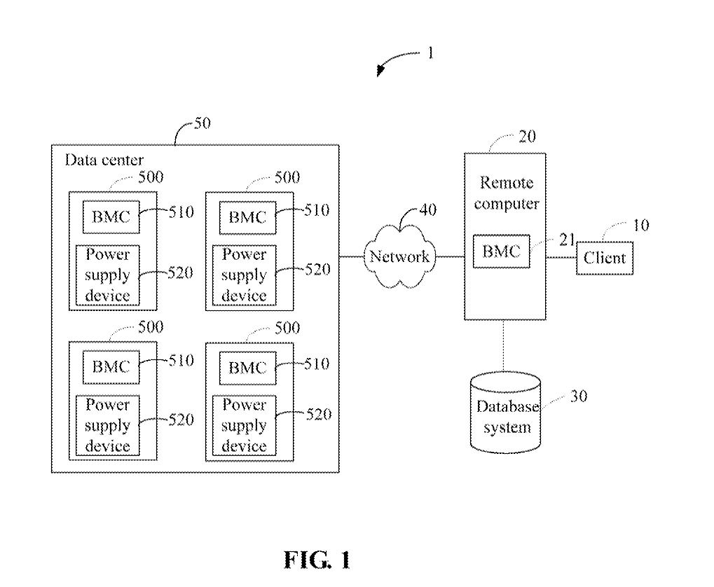

FIG. 1 is a block diagram of one embodiment of a power supply control system 1. In one embodiment, the power supply control system 1 may include a data center 50, a network 40, a database 30, a remote computer 20, and one or more clients 10. The power supply control system 1 may be used to efficiently start the data center 50.

The data center 50 is located behind a firewall, and is connected to the network 40. The network 40 may be, but is not limited to, a wide area network (e.g., the Internet) or a local area network. The firewall is used to protect the data center 50 from unauthorized access and secure information of the data center 50. The data center 50 is designed for cloud computing capability and capacity and includes a plurality of cloud servers 500. Each of the cloud servers 500 includes a baseboard management controller (BMC) 510 and a power supply device 520. The BMC 510 is used to store information of the power supply device 520. The information of the power supply device 520 may include a serial number of the power supply device 520, a power rating of the power supply device 520, a voltage of the power supply device 520 and a current of the power supply device 520. The BMC 510 further starts the power supply device 520 at a predetermined time (e.g., 6:00 AM). For example, the BMC 510 sends a command to start the power supply device 520 when a current time is 6:00 AM. The power supply device 520 is connected to the mains power grid and provides power to the cloud server 500.

The remote computer 20 is a dynamic host configuration protocol (DHCP) server, and is connected to the network 40. The remote computer 20 is installed with a DHCP service. In one embodiment, the remote computer 20 assigns internet protocol (IP) addresses to the cloud server 500 by the DHCP service via the network 40. In one embodiment, the remote computer 20 uses dynamic allocation to assign the IP addresses to the cloud servers 500. For example, when the remote computer 20 receives a request from a cloud server 500 via the network 40, the remote computer 20 dynamically assigns an IP address to the requesting cloud server 500.

The remote computer 20 includes a BMC 21. The BMC 21 is used to send the command to the BMC 510 via the network 40. For example, the BMC 21 sends the command to the BMC 510, so that the BMC 510 controls the power supply device 520 to start at 6:00 AM. In one embodiment, the remote computer 20 may be a personal computer (PC), a network server, or any other data-processing equipment. Further details of the remote computer 20 will be described below.

The database system 30 is connected to the remote computer 20 using open database connectivity (ODBC) or java database connectivity (JDBC), for example. The database system 30 may store the data which is obtained by the remote computer 20 from the cloud servers 500.

The client 10 is electronically connected to the remote computer 20. The client 10 may be a personal computer (PC), a network server, or any item of other data-processing equipment. In one embodiment, the client 50 may provide a user interface for a user to control one or more operations of the remote computer 20. The user may input a password and a name by an input device (e.g., a keyboard) of the client 10 into the user interface to access the remote computer 20.

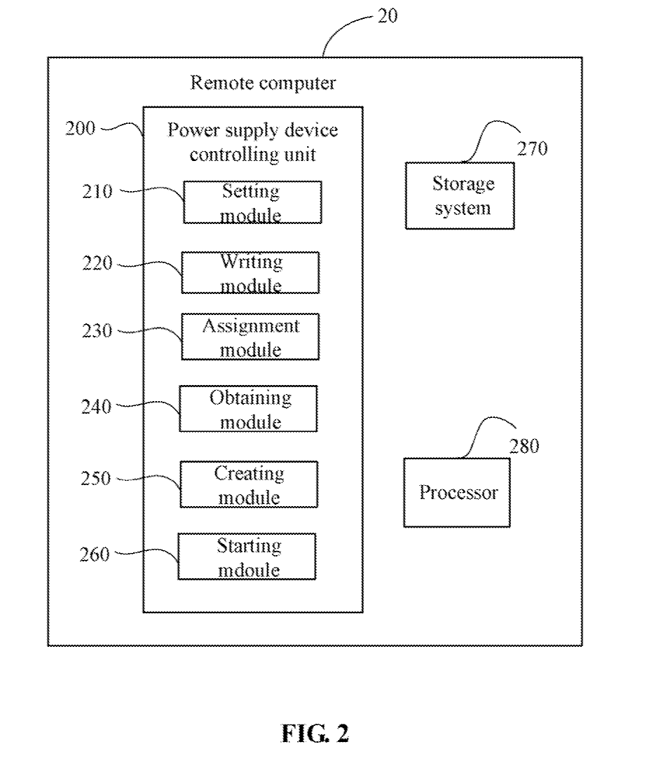

FIG. 2 is a block diagram of one embodiment of the remote computer 20. The remote computer 20 includes a power supply controlling unit 200. The power supply controlling unit 200 may be used to control the power supply device 520 of each of the cloud servers 500. In one embodiment, the remote computer 20 includes a storage system 270, and at least one processor 280. In one embodiment, the power supply controlling unit 200 includes a setting module 210, a writing module 220, an assignment module 230, an obtaining module 240, a creating module 250, and a starting module 260. The modules 210-260 may include computerized code in the form of one or more programs that are stored in a storage system 270. The computerized code includes instructions that are executed by the at least one processor 280 to provide functions for the modules 210-260. The storage system 270 may be a memory, such as an EPROM memory chip, HDD, or flash memory stick.

The setting module 210 sets parameters that are used to send the command to each of the BMCs 510. In one embodiment, the parameters include a time interval (e.g., two minutes) to send the command to each of the BMCs 510 and a sequence to send the command to each of the BMCs 510. In one embodiment, the sequence may be determined by a power rating of each of the power supply devices 520 corresponding to the BMCs 510, or determined by a serial number of each of the power supply devices 520 corresponding to the BMCs 510.

The writing module 220 writes the parameters into the BMC 21. In one embodiment, the writing module 220 invokes an intelligent platform management interface (IPMI) command to write the parameters into the BMC 21.

The assignment module 230 assigns an IP address by the DHCP service to each of the cloud servers 500 of the data center 50 when the power supply device 520 corresponding to each of the BMCs 510 is powered on. Each of the cloud servers 500 can communicate with the remote computer 20 by the assigned IP address.

The obtaining module 240 obtains information from each of the BMCs 510. In one embodiment, as mentioned above, the information may include the serial number of each of the BMCs 510, the serial number of each of the power supply devices 520, the power rating of each of the power supply devices 520, the voltage of each of the power supply devices 520 and the current of each of the power supply devices 520.

The creating module 250 creates a list in the BMC 21. In one embodiment, the list includes information obtained from each of the BMCs 510.

The starting module 260 sends the command every time interval to each of the BMCs 510 in the sequence to start the power supply device 520 corresponding to each of the BMCs 510 according to the list. In one embodiment, the starting module 260 searches the list to search the serial number of each of the BMCs 510 according to the sequence, and sends the command every time interval (e.g., two minutes) to each of the BMCs 510 to start the power supply device 520 corresponding to each of the BMCs 510.

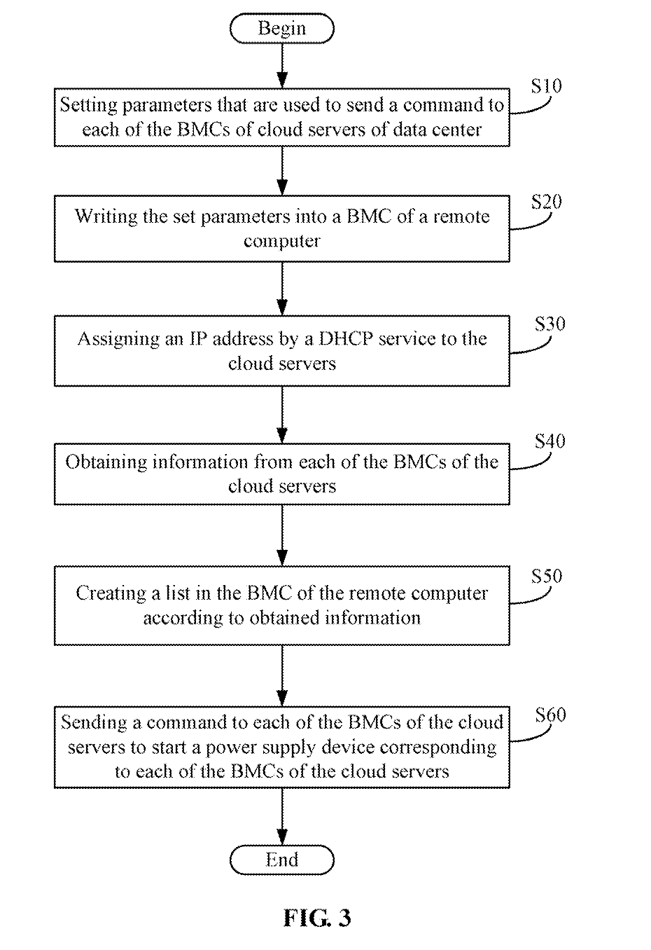

FIG. 3 is a flowchart of one embodiment of a power supply control method. Depending on the embodiment, additional steps may be added, others deleted, and the sequence of the steps may be changed.

In step S10, the setting module 210 sets parameters that are used to start each of the power supply devices 520 corresponding to the cloud servers 500 of the data center 50. As mentioned above, the parameters include a time interval (e.g., two minutes) to send the command to each of the BMCs 510 and a sequence to send the command to each of the BMCs 510. In one embodiment, if the sequence is determined by the power rating of each of the power supply devices 520 corresponding to the BMCs 510, the sequence may be from the largest power to the smallest power. For example, assuming that the data center 50 includes four BMCs 510 (e.g., namely A1, B1, C1, and D1), if the power rating of the power supply device 520 corresponding to A1 is 200 Watt (W), the power rating of the power supply device 520 corresponding to B1 is 230 W, the power rating of the power supply device 520 corresponding to C1 is 130 W, the power rating of the power supply device 520 corresponding to D1 is 120 W, the sequence is to send the command A1 first, send the command B1 second, send the command C1 third, and send the command D1 fourth.

In one embodiment, if the sequence is determined by the serial number of each of the power supply devices 520 corresponding to the BMCs 510, the sequence may be from the largest serial number to the smallest serial number. For example, if the serial number of the power supply device 510 corresponding to A1 is V2012423, the serial number of the power supply device 510 corresponding to B1 is V2012422, the serial number of the power supply device 510 corresponding to C1 is V2012421, the serial number of the power supply device 510 corresponding to D1 is V2012427, the sequence is to send the command to D1 first, send the command A1 second, send the command B1 third, and send the command C1 fourth.

In step S20, the writing module 220 writes the parameters into the BMC 21. In one embodiment, the writing module 220 invokes an intelligent platform management interface (IPMI) command to write the parameters into the BMC 21.

In step S30, the assignment module 230 assigns an IP address by the DHCP service to each of the cloud servers 500 when the power supply device 520 corresponding to each of the BMCs 510 is powered on. For example, the cloud server 500 is assigned an IP address 10.153.24.12, the remote computer 20 communicates with the cloud server 500 using the IP address 10.153.24.12. When the cloud server 500 is powered on by the power supply device 520, the cloud server 500 receives the IP address 10.153.24.12 from the DHCP server. The assignment module 230 assigns the IP address every time interval (e.g., two minutes) to each of the cloud servers 500 of the data center 50 in the sequence.

In step S40, the obtaining module 240 obtains information from each of the BMCs 510. As mentioned above, the information may include a serial number of each of the BMCs 510, a serial number of each of the power supply devices 520, a power rating of each of the power supply devices 520, a voltage of each of the power supply devices 520 and a current of each of the power supply devices 520.

In step S50, the creating module 250 creates a list in the BMC 21. In one embodiment, the list includes information obtained from each of the BMCs 510. For example, if the data center 50 includes four BMCs 510, the list may include five columns and five rows as follows:

| | Serial number | | | |
|---|---|---|---|---|
| | of the power | Power the | Voltage | Current the |
| | supply device | power | the power | power |
| Serial number | corresponding | supply | supply | supply |
| of the BMC | to the BMC | device | device | device |
| A1 | V2012423 | 200 W | 100 V | 2 Ampere |
| B1 | V2012422 | 230 W | 115 V | 2 Ampere |
| C1 | V2012421 | 130 W | 65 V | 2 Ampere |
| D1 | V2012427 | 120 W | 100 V | 1.2 Ampere |

In step S60, the starting module 260 sends the command every time interval to each of the BMCs 510 in the sequence to start the power supply device 520 corresponding to each of the BMCs 510 according to the list. For example, assuming that the sequence is from the largest power to the smallest power, the starting module 260 searches the list to search the BMC B1 which corresponds to 230 W, and sends the command to the BMC B1 to start the power supply device V2012422. Two minutes later, the starting module 260 sends the command to the BMC A1 to start the power supply device V2012423. Two minutes later, the starting module 260 sends the command to the BMC C1 to start the power supply device V2012421. Two minutes later, the starting module 260 sends the command to the BMC D1 to start the power supply device V2012427.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A remote computer, the remote computer in communication with cloud servers of a data center, comprising:
a storage system;
at least one processor; and
one or more programs stored in the storage system and being executable by the at least one processor, the one or more programs comprising:
a writing module operable to write parameters into a baseboard management controller (BMC) of the remote computer, wherein the parameters comprise a time interval to send a command to each of the BMCs of the cloud servers and a sequence to send the command to each of the BMCs of the cloud servers;
an assignment module operable to assign an internet protocol (IP) address by a dynamic host configuration protocol (DHCP) service to each of the cloud servers;
an obtaining module operable to obtain information from each of the BMCs of the cloud servers;
a creating module operable to create a list in the BMC of the remote computer, wherein the list comprises the information obtained from each of the BMCs of the cloud servers; and
a starting module operable to send the command every time interval to each of the BMCs of the cloud servers in the sequence to start a power supply device corresponding to each of the BMCs of the cloud servers according to the list.

2. The remote computer of claim 1, wherein the information comprises a serial number of each of the BMCs of the cloud servers, a serial number of each of the power supply devices corresponding to the BMCs of the cloud servers, a power rating of each of the power supply devices corresponding to the BMCs of the cloud servers, a voltage of each of the power supply devices corresponding to the BMCs of the cloud servers, and a current of each of the power supply devices corresponding to the BMCs of the cloud servers.

3. The remote computer of claim 2, wherein the sequence is determined by the serial number of each of the power supply devices corresponding to the BMCs of the cloud servers.

4. The remote computer of claim 2, wherein the sequence is determined by the power rating of each of the power supply devices corresponding to the BMCs of the cloud servers.

5. The remote computer of claim 1, wherein the starting module further searches the list to search the BMCs of the cloud servers.

6. A power supply control method implemented by a remote computer, the remote computer in electronic communication with cloud servers of a data center, the method comprising:
writing parameters into a baseboard management controller (BMC) of the remote computer, wherein the parameters comprise a time interval to send a command to each of the BMCs of the cloud servers and a sequence to send the command to each of the BMCs of the cloud servers;
assigning an internet protocol (IP) address by a dynamic host configuration protocol (DHCP) service to each of the cloud servers;
obtaining information from each of the BMCs of the cloud servers;
creating a list in the BMC of the remote computer, wherein the list comprises the information obtained from each of the BMCs of the cloud servers; and
sending the command every time interval to each of the BMCs of the cloud servers in the sequence to start a power supply device corresponding to each of the BMCs of the cloud servers according to the list.

7. The method of claim 6, wherein the information comprises a serial number of each of the BMCs of the cloud servers, a serial number of each of the power supply devices corresponding to the BMCs of the cloud servers, a power rating of each of the power supply devices corresponding to the BMCs of the cloud servers, a voltage of each of the power supply devices corresponding to the BMCs of the cloud servers, and a current of each of the power supply devices corresponding to the BMCs of the cloud servers.

8. The method of claim 7, wherein the sequence is determined by the serial number of each of the power supply devices corresponding to the BMCs of the cloud servers.

9. The method of claim 7, wherein the sequence is determined by the power rating of each of the power supply devices corresponding to the BMCs of the cloud servers.

10. The method of claim 6, wherein the list is searched to search the BMCs of the cloud servers.

11. A non-transitory computer-readable medium having stored thereon instructions that, when executed by a remote computer, the remote computer in electronic communication with cloud servers of a data center, causing the cloud server to perform a power supply control method, the method comprising:
writing parameters into a baseboard management controller (BMC) of the remote computer, wherein the parameters comprise a time interval to send a command to each of the BMCs of the cloud servers and a sequence to send the command to each of the BMCs of the cloud servers;
assigning an internet protocol (IP) address by a dynamic host configuration protocol (DHCP) service to each of the cloud servers;
obtaining information from each of the BMCs of the cloud servers;
creating a list in the BMC of the remote computer, wherein the list comprises the information obtained from each of the BMCs of the cloud servers; and
sending the command every time interval to each of the BMCs of the cloud servers in the sequence to start a power supply device corresponding to each of the BMCs of the cloud servers according to the list.

12. The medium of claim 11, wherein the information comprises a serial number of each of the BMCs of the cloud servers, a serial number of each of the power supply devices corresponding to the BMCs of the cloud servers, a power rating of each of the power supply devices corresponding to the BMCs of the cloud servers, a voltage of each of the power supply devices corresponding to the BMCs of the cloud servers, and a current of each of the power supply devices corresponding to the BMCs of the cloud servers.

13. The medium of claim 12, wherein the sequence is determined by the serial number of each of the power supply devices corresponding to the BMCs of the cloud servers.

14. The medium of claim 12, wherein the sequence is determined by the power rating of each of the power supply devices corresponding to the BMCs of the cloud servers.

15. The medium of claim 11, wherein the list is searched to search the BMCs of the cloud servers.
